(19) United States
(12) Patent Application Publication
(10) Pub. No.: US 2015/0065147 A1
(43) Pub. Date: Mar. 5, 2015

(54) WIRELESS COMMUNICATION SYSTEM, WIRELESS COMMUNICATION METHOD, AND BASE STATION

(71) Applicant: HITACHI, LTD., Tokyo (JP)

(72) Inventor: Mikio KUWAHARA, Tokyo (JP)

(21) Appl. No.: 14/447,996

(22) Filed: Jul. 31, 2014

(30) Foreign Application Priority Data
Sep. 5, 2013 (JP) 2013-183571

(51) Int. Cl. H04W 36/32; H04W 12/06; H04W 4/06; H04W 8/02

(52) U.S. Cl. CPC H04W 36/32; H04W 8/02; H04W 12/06; H04W 4/06
USPC 455/441

(57) ABSTRACT

When each of a plurality of base stations performs communication with a terminal using a different frequency channel, a first frequency channel for initial connection and a second frequency channel for efficiently using a frequency resource are divided, and handover from a first base station having the first frequency channel and a second base station having the second frequency channel are performed by being led by a base station based on mobility of a terminal.

### CROSS-REFERENCE TO RELATED APPLICATIONS

This application claims the priority of Japanese Patent Application No. 2013-183571, filed on Sep. 5, 2013, which is incorporated herein by reference in its entirety.

### BACKGROUND OF THE INVENTION

1. Field of the Invention

The present invention relates to a wireless communication technology, and especially relates to a wireless communication device and a wireless communication system for providing a wireless communication service on an airport surface.

2. Description of the Related Art

A service in which data is transmitted/received between a terminal mounted on an aircraft and a base station in an airport by wireless communication, and operation information and information to passengers in the aircraft are provided on an airport surface has been examined. On the airport surface, an aircraft usually taxis on a designated runway, and thus the air craft repeats departing/landing almost through the same route. Characteristics in the wireless communication of the airport surface that need to be taken into consideration, and problems that occurs when a new aircraft lands and starts communication will be described below.

(1) Load Balance

When a new aircraft lands and starts communication, a location where a terminal mounted on the aircraft starts connection to a base station in the airport is almost the same every time. Therefore, each aircraft captures radio waves of the same frequency transmitted/received by the same base station.

Usually, in the airport, a takeoff/landing direction of a runway to be used is changed according to the weather condition, such as a wind. However, the direction is not frequently changed within one day. Therefore, when seeing a certain time zone, a runway used by aircrafts is the same, and a route into which the aircrafts starts taxiing is the same. Further, a base station transmits radio waves in a specific location or a specific direction, and thus a base station to be connected is determined according to a location where the terminal mounted on an aircraft receives the radio waves. When a frequency used by each base station is changed in order to avoid interference between base stations, a location where taxiing is first started is almost the same. Therefore, a frequency of radio waves first received by the terminal mounted on an aircraft is biased to a specific frequency. Further, there is a small number of shielding in the airport, and thus the radio waves reach a distance without being interrupted. A carrier to interference and noise ratio (CINR) of the frequency of a once-connected base station is less likely to be deteriorated than a frequency of another base station. As a result, a phenomenon occurs, in which, even if an aircraft (terminal) is moved while a frequency to which the aircraft is connected is biased to a specific frequency, handover is not caused. Usually, in a wireless communication system of the airport surface, a system is considered, in which 60 MHz is used as a bandwidth of the system as a whole, and 60 MHz is configured from twelve frequencies of every 5 MHz. Due to the above-described characteristic of the wireless communication of the airport surface, the terminals are biased to a specific frequency of the twelve frequencies, and only the specific frequency is used. As a result, a frequency having a low use rate and a frequency having an extremely high use rate appear, and the frequency use efficiency of the system as a whole is decreased. Therefore, it is important to improve the use efficiency of the frequencies, and to appropriately achieve balance of the frequencies used by the aircrafts (terminals), that is, to achieve load balance.

(2) Handling of High-Speed Movement at Taxiing

A movement speed of an aircraft at taxiing is faster than that of an automobile or a train. There is an upper limit to the movement speed that can be supported by the wireless communication system. At taxiing, it is difficult to maintain a favorable communication state since the movement speed is fast, and there is a possibility that the initial connection is failed. Therefore, in the wireless communication system of the airport surface, prevention of failure of the initial connection is an issue.

At taxiing, the aircraft (terminal) moves in the airport at a high speed. Further, when the frequency that can be used in the airport is a high frequency (for example, 5 GHz), a fading frequency is particularly higher than that of a 800 MHz or 2 GHz band used in the normal wireless communication system. Therefore, influence of interference by a signal deviated in a time axis direction due to multipath is more serious than that in the usual wireless communication system, and a communication error is caused even in a state where the CINR is sufficiently high. Therefore, a modulation system having a high degree of modulation (for example, 64 quadrature amplitude modulation (QAM)) cannot be used. To increase a connection rate of an aircraft moving at a high speed at initial connection, a modulation system having a low degree of modulation, such as quadrature phase shift keying (QPSK), is used. The modulation system having a low degree of modulation consumes a large amount of radio resources. Therefore, it is not desirable to perform resource allocation in which an aircraft (terminal) in low-speed movement or stoppage, and an aircraft (terminal) in high-speed movement use the same frequency, and scramble for the frequency resources.

(3) Handover Control from after Landing to a Stop Gate

Usually, aircrafts of a plurality of airline companies perform takeoff and landing on the airport, and gates through which the passengers get on and off are different according to the airline companies. Therefore, a means to recognize the aircraft or an airline company to which the aircraft belongs, then, to know the gate where the aircraft finally stops, to determine a handover destination using the information, and to appropriately move the aircraft (terminal) to the handover destination is necessary.

### SUMMARY OF THE INVENTION

To realize the resource allocation corresponding to the high-speed movement at taxiing, it is necessary to perform handover control led by a base station.

Regarding the handover led by a base station, there is a technology described in WO 2005/109689 A, for example. In WO 2005/109689 A, reasons that the handover led by a base station is necessary are “a base station (BS) becomes in an overload state, and load sharing for distributing a BS load to an adjacent BS is necessary”, and “to respond to change of an uplink state of a mobile subscriber station (MSS)”. However, the technology necessary for the wireless communication system of the airport surface is not a technology to let the terminal to be connected go to another frequency after it becomes in a high-load state, but a technology for increasing a connection rate, considering the high-speed movement at initial connection, and a handover technology. Further, as described above, a handover selection method led by a base station considering a point that locations of the gates are different depending on the airline companies is necessary. Such a problem peculiar to the wireless communication system of the airport surface is not sufficiently solved by the solution described in WO 2005/109689 A.

The present invention has been made to solve the above problem, and an objective is to easily ensure radio resources, to improve the connection rate of terminals, and to stabilize the communication state at high-speed movement even in a state where the movement speed of an aircraft right after landing is fast, in consideration of the characteristics of the wireless communication of the airport surface. Further, an objective is to effectively use frequency resources.

To solve the above problem, in the present invention, in a wireless communication system in which each of a plurality of base stations performs communication with a terminal having a group attribute using a different frequency channel, the base station receiving, in a connection procedure with a terminal, a terminal ID or a group ID of a group to which the terminal belongs from the terminal, transmitting the terminal ID or the group ID to an authentication device, receiving information extracted as a result of authentication based on the terminal ID or the group ID from the authentication device, measuring, regarding the terminal in data transmission/reception after completion of the connection procedure, mobility of the terminal, and instructing the terminal to be handed over to a handover destination based on the information received from the authentication device when the mobility of the terminal becomes a threshold set in advance or less.

Further, when each of a plurality of base stations performs communication with a terminal using a different frequency channel, a first frequency channel for initial connection and a second frequency channel for efficiently using a frequency resource are divided, and handover from a first base station having the first frequency channel to a second base station having the second frequency channel is performed by being led by a base station based on mobility of a terminal.

According to the present invention, the base station can stably secure communication radio resources even in a state where the movement speed of the aircraft right after landing is fast, and the connection rate can be improved and the communication state at the high-speed movement can be stabilized. Further, a small number of times of handover can be maintained without performing handover more than necessary. Therefore, the frequency resources can be effectively used.

### BRIEF DESCRIPTION OF THE DRAWINGS

FIG. 1 is a diagram illustrating an example of an airport surface;

FIG. 2 is a diagram illustrating an example of frequency allocation of airport surface communication;

FIG. 3 is a schematic diagram describing communication of the airport surface at taxiing;

FIG. 4 is a diagram illustrating an example of when there is a plurality of airline companies on the airport surface;

FIG. 5 is a diagram illustrating a configuration of a base station and a terminal in an embodiment of the present invention;

FIG. 6 is a sequence diagram illustrating a communication procedure from initial connection to handover in an embodiment of the present invention;

FIG. 7 is a diagram illustrating a configuration of a base station in an embodiment of the present invention; and

FIG. 8 is a diagram illustrating a flow performed in an RRM of a base station in an embodiment of the present invention.

### DESCRIPTION OF THE PREFERRED EMBODIMENTS

Hereinafter, embodiments will be described with reference to the drawings.

### Embodiment 1

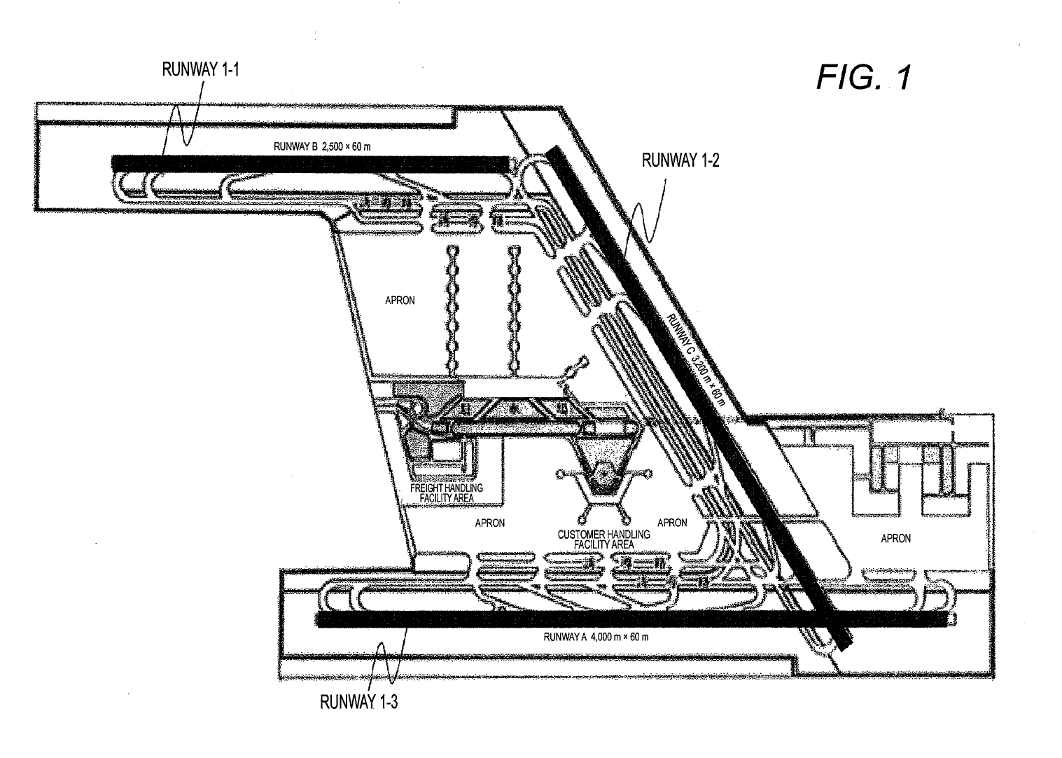

FIG. 1 is a diagram illustrating an example of an airport structure.

The example of the drawing illustrates three runways (1-1, 1-2, and 1-3). A terminal mounted on an aircraft searches for a plurality of frequencies transmitted by a plurality of base stations, and measures electric field intensity of signals, when the aircraft has landed. The terminal mounted on the aircraft finds a base station that transmits a frequency having largest reception electric field intensity, and starts a connection procedure to the base station.

The reason why an airport has a plurality of runways is to change the direction of departing/landing by changing a runway from/into which departing/landing is performed according to the weather condition, such as a wind direction. Further, a type of aircraft that can depart/land differs according to the length of a runway. Therefore, while a runway may be changed depending on a time zone, landing is repeated in the same direction over a relatively long period. As a result, most of aircrafts landing one after another perform a connection request to a base station that covers an end of the runway on which the aircrafts repeats the landing as a cover area, and terminals mounted on most of the aircrafts connect to a frequency used by the base station.

In the airport, there is no obstacle around the runway. Therefore, there is no attenuation of radio waves by the obstacle, unlike normal cellular communication, and the radio waves can easily reach a distance. Further, radio waves transmitted by a certain base station easily causes interference with radio waves transmitted by a distant base station. Therefore, in the wireless communication system of the airport surface, when there is a band of 60 MHz as the system as a whole, for example, a configuration in which the band is divided into 12 channels, a reuse rate is decreased, and frequency bands are used has been examined.

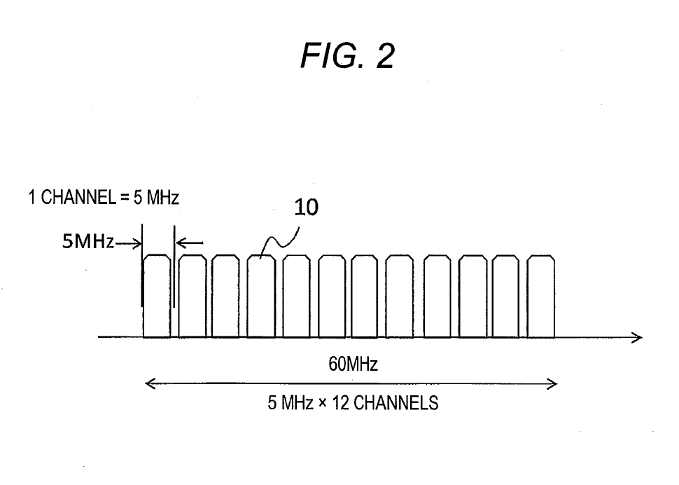

FIG. 2 illustrates a detailed configuration example of the band division examined in the wireless communication system of the airport surface.

Here, the reference sign 10 is a band (1 channel) capable of providing a service, and in the case illustrated in FIG. 2, a bandwidth of one channel is 5 MHz. Therefore, describing the phenomenon caused at landing again with reference to FIG. 2, almost all of the terminals mounted on the aircrafts landing on the airport one after another perform a connection request to the specific frequency (for example, 10) of FIG. 2, and receive a service with the frequency.

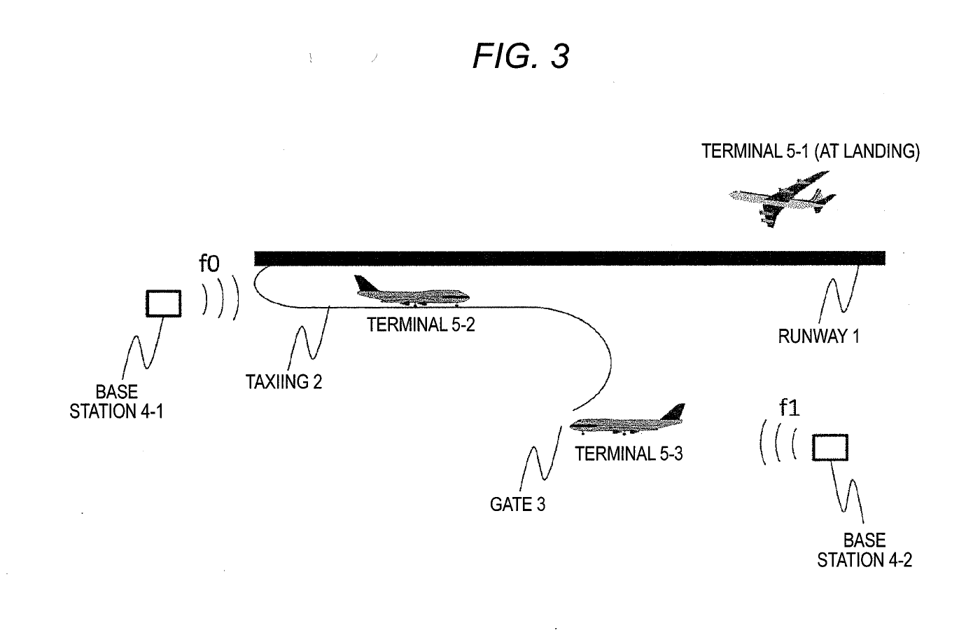

FIG. 3 is a schematic diagram describing communication of the airport surface at taxiing.

First, an aircraft starts landing from a right end of a runway, and is evacuated to a lane of a taxiing 2 at around a left end of the runway. After the evacuation, or immediately before the evacuation, airport surface communication is started. Here, communication with a close base station 4-1 (that uses a frequency f0) is performed. An aircraft 5-2 continues to move at a relatively high movement speed (for example, at about 70 km/h) during taxiing. Finally, the aircraft stops at a gate 3, and getting on and off of passengers becomes possible.

When the aircraft comes close to the gate 3, it is desirable to connect with another base station 4-2 (that uses a frequency f1) newly close to the aircraft. Arrangement of the base station is determined such that the base station 4-2 can realize the best communication near the gate. However, as described above, the radio waves reach a distance, and thus signal strength of the base station 4-1 is not deteriorated. Accordingly, handover led by the terminal is not easily caused. As a result, traffic is biased to a specific frequency and a specific base station, and thus the frequency use efficiency is decreased. To prevent it, a procedure to forcibly hand over the terminal to the base station 4-2, which is led by a base station, is necessary.

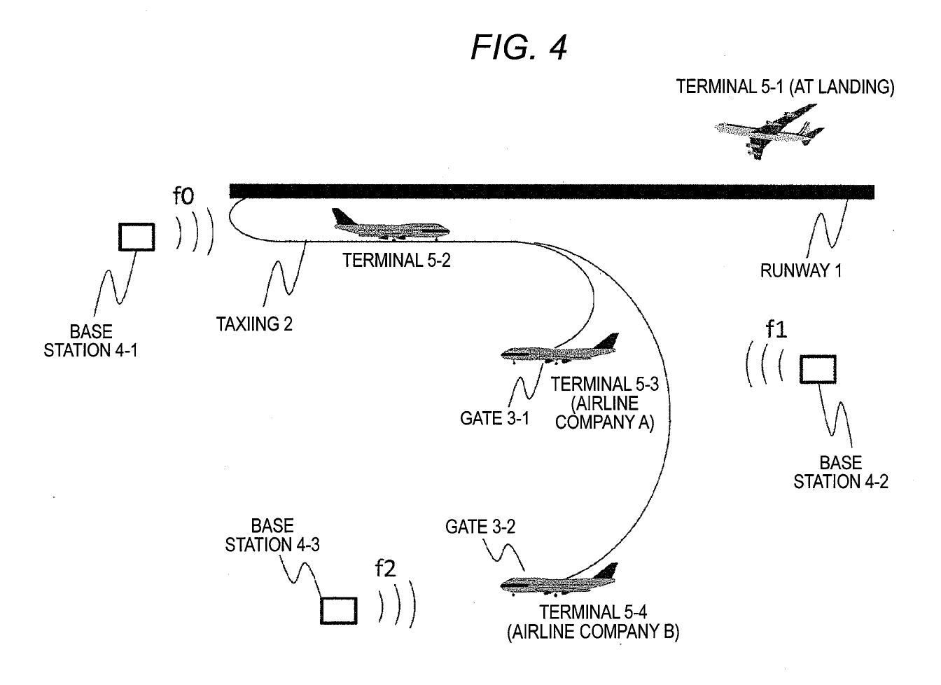

FIG. 4 is a diagram illustrating an example of when there is a plurality of airline companies on the airport surface.

The example illustrates a case in which aircrafts of the plurality of airline companies land one after another. First, an aircraft 5-1 starts landing from a right end of a runway, and is evacuated to a lane of the taxiing 2 at around a left end of the runway. After the evacuation, or immediately before the evacuation, airport surface communication is started. Here, communication with a close base station 4-1 (that uses a frequency f0) is performed. An aircraft 5-2 continues to move at a relatively high movement speed (for example, at about 70 km/h) during taxiing. Finally, the aircraft stops at a gate 3-1 or a gate 3-2 depending on the airline company. Which gate the aircraft stops at depends on the airline company to which the aircraft belongs. Therefore, in the present invention, whether handover is performed from the base station 4-1 to the base station 4-2 or to the base station 4-3 is determined, and the handover is instructed to the aircraft, which is led by a base station.

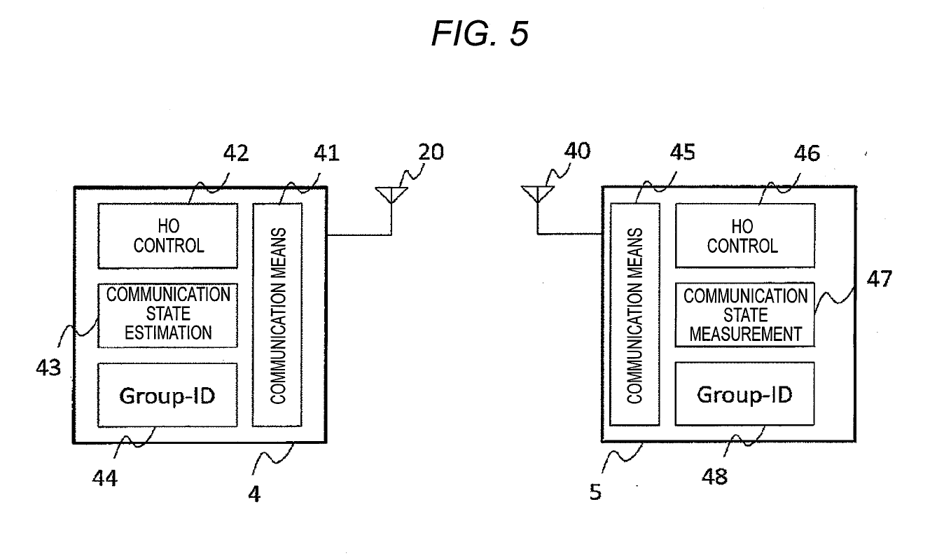

FIG. 5 is a configuration diagram of a system configured from a base station and a terminal according to an embodiment of the present invention.

A base station 4 includes an antenna 20 for wireless communication and a communication means 41 connected with the antenna 20. The communication means 41 is configured from a modem and an RF circuit, and receives radio waves from the antenna 20 and communicates with a terminal 5. The terminal 5 side also includes an antenna 40 facing the base station 4 and a communication means 45. The communication means 41 of the base station is connected with a communication state estimation means 43 and a group ID determination means 44. The terminal-side communication means 45 is connected with a communication state measurement means 47 and a group ID storage means 48. The terminal 5 notifies the base station 4 of a terminal ID or a group ID to which the terminal belongs when sending a connection request to the base station 4. The terminal ID or the group ID is stored in the group ID storage means 48. The base station 4 records the received terminal ID in the group ID determination means 44 as a context. Further, the terminal 5 periodically reports a communication state measurement result measured in the communication state measurement means 47 to the base station 4. The base station 4 can estimate mobility of the terminal 5 according to intensity of variation of the measurement result reported from the terminal 5. Alternatively, the base station 4 can estimate the mobility of the terminal 5 by receiving a signal transmitted from the terminal 5 (for example, a pilot signal), and estimating a fading frequency by measuring a time variation component of the signal. The base station 4 performs the mobility estimation using the communication state estimation means 43, and records a state of latest mobility on a memory included in the communication state estimation means 43. The base station 4 includes a handover (HO) control unit 42. The HO control unit 42 checks the latest mobility of the terminal 5 recorded in the communication state estimation means 43, and performs handover determination of the terminal 5 when a value of the mobility first falls below a threshold determined in advance. The HO control unit 42 determines whether performing the handover of the terminal 5, and which base station the terminal 5 is handed over, and instructs the handover led by the base station to the terminal 5 through the communication means 41. When the base station 4 instructs the handover, the base station 4 checks the context of the terminal 5, and estimate a gate that is a final stop destination of the terminal from the group ID of the terminal. Then, the base station 4 selects a base station of the handover destination based on the location of the estimated gate, and includes an ID of the base station in the handover instruction, and sends the instruction to the terminal 5. The HO control unit 46 at the terminal side, which has received the handover instruction from the base station 4 through the communication means 45, performs the handover to the base station of the instructed base station ID according to a handover procedure.

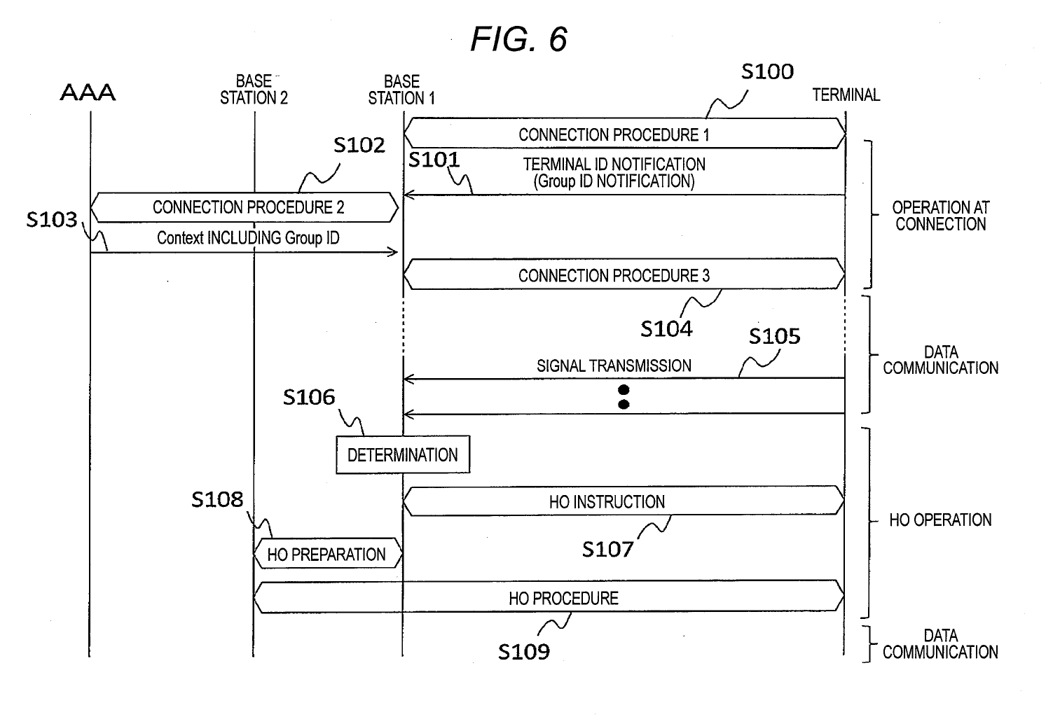

FIG. 6 is a diagram describing a sequence from initial connection to handover in an embodiment of the present invention.

FIG. 6 illustrates a communication sequence among a terminal (aircraft), a base station 1 (a first connected base station), and a base station 2 (a base station to be finally connected).

First, a terminal of the aircraft having landed and entered a taxiing lane selects the base station 1 close to an end of the taxiing lane as a first connection destination, and performs a connection procedure 1 (S100). At this time, the terminal notifies the base station of a terminal ID or a group ID of a group to which the terminal belongs as a message (S101). The base station 1 that has received the terminal ID or the group ID of the group to which the terminal belong performs a connection procedure 2 to an authentication, authorization and accounting (AAA, triple A) that is an authentication device (S102). The AAA performs authentication based on the terminal ID, extracts the context including the group ID, and transmits the context to the base station 1 (S103). A connection operation is completed through the procedure, such as authentication (the connection procedure 3, S104), and data communication is started. The data communication includes communication of an up signal, and at that time, a signal, such as a pilot signal (S105), is transmitted from the terminal to the base station 1. The base station 1 estimates the mobility of the terminal using the pilot signal. Magnitude of the mobility is periodically determined by comparison with a threshold of mobility (S106), and the base station 1 determines to perform handover led by the base station when an estimated value first falls below the threshold of mobility determined in advance. The base station 1 transmits a handover instruction (S107) to the terminal. A message of the instruction includes information of the base station 2 that is a handover destination. Further, the base station 1 transmits a HO preparation message (S108) to the base station 2 in order to notify that there is handover of the terminal. The base station 2 that has received the message performs a handover procedure (S109) with the terminal.

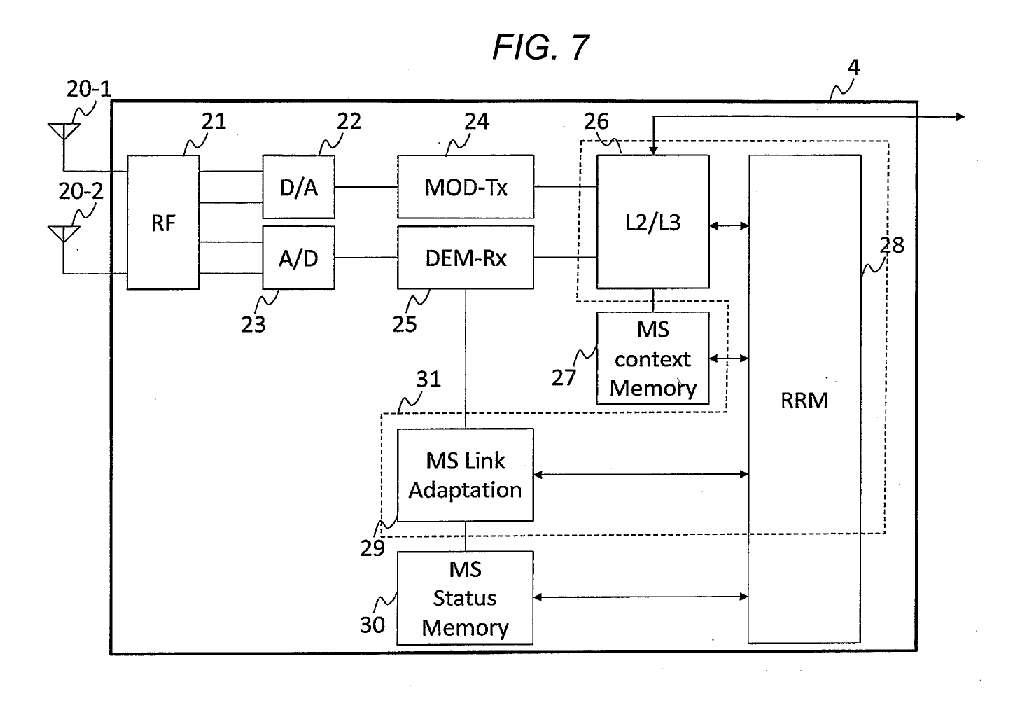

FIG. 7 is a diagram illustrating a configuration of a base station in an embodiment of the present invention.

While FIG. 5 illustrates the base station 4 by the function block, FIG. 7 illustrates a configuration of a base station by a hardware image. The base station includes two antennas (20-1 and 20-2). The antennas are connected to an RF circuit 21. The RF circuit 21 converts a signal received by the antennas into a base band, converts a transmission signal from a base band signal into an RF signal and amplifies the signal, and transmits the signal from the antennas. A D/A converter is connected to a transmission side of the RF circuit 21, and an A/D converter is connected to a reception side, and conversion of transmission/reception signals between an analog signal and a digital signal is performed.

A transmission modem unit 24 converts a signal generated by an L2 (layer 2)/L3 (layer 3) unit 26 into a modulation signal that can be wirelessly transmitted. A reception modem unit 25 takes out a pilot signal included in a reception signal. The reception modem unit 25 estimates a state of a propagation path from the pilot signal, then detects/demodulates a data signal, and takes out the information. Further, the reception modem unit 25 inputs the state of the propagation path estimated from the pilot signal to a terminal link adaptation unit 29. The terminal link adaptation unit 29 estimates the mobility of the terminal from the estimated state of the propagation path. The estimated mobility is recorded on a state memory 30. Variation of a down signal reported by the terminal can be used for the mobility estimation. The terminal reports a state of a down line to the base station using a channel quality indicator (CQI) channel, and the like. The mobility of the terminal can be estimated using variation of a report value reported by the terminal using the CQI channel to the base station.

The reception modem unit 25 transmits received data to the L2/L3 unit 26. The L2/L3 unit 26 divides the received data into control data and user data, and transmits the user data to a network side. The L2/L3 unit 26 transmits the control data to a radio resource management unit (RRM) 28, and uses the control data for management of radio resources. The information, such as the terminal ID, received from the terminal in the connection procedure is accumulated in a context memory 27. A latest estimation result of the mobility of the terminal estimated using the information transmitted from the terminal to the base station is accumulated in the state memory 30. The RRM 28 periodically compares the latest estimation result of the mobility with a threshold. Then, when the latest estimation result of the mobility first falls below the threshold after the terminal is connected to the base station, the RRM 28 determines performance of handover of the terminal. When having determined the performance of handover, the RRM 28 determines a base station of a handover destination from a list based on the terminal ID accumulated in the context memory 27. The list is determined at the time of system design of the wireless communication system, and is set in the base station in advance. By the determination of the performance of handover, the RRM performs the handover sequence led by the base station (see FIG. 6).

A range 31 surrounded by a broken line in FIG. 7 is realized by a CPU. That is, the block surrounded by the range 31 is embodied as a sub-routine of a program.

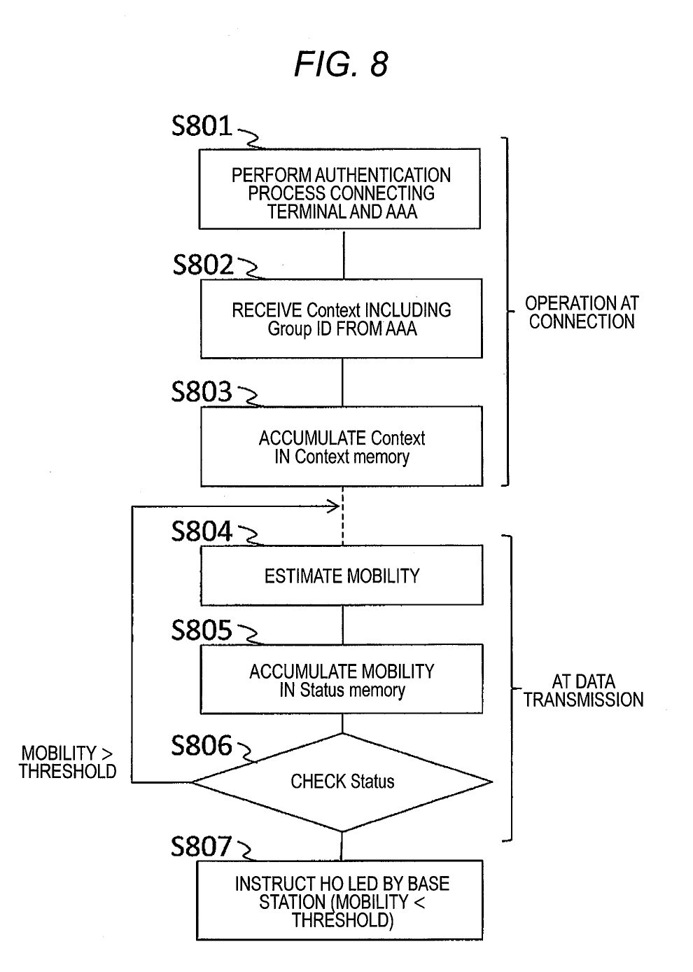

FIG. 8 is a flowchart describing processing of a base station in an embodiment of the present invention.

FIG. 8 illustrates processing performed by the RRM of the base station.

In an operation at connection of the terminal, the RRM performs the authentication process connecting the terminal and the AAA in the above-described connection procedure (S801), and receives the message including the context including the group ID (or the terminal ID) from the AAA (S802). The RRM recognizes and takes out the context including the group ID (or the terminal ID), and accumulates the taken ID and the context in the context memory (S803).

After the operation at connection is complete and data transmission is started, the RRM estimates the mobility of the terminal from the pilot signal received from the terminal or the variation of the CQI channel reported by the terminal (S804). The RRM accumulates the estimated mobility in the state memory (S805).

The RRM periodically estimates the mobility and accumulates an estimation result in the state memory, and compares the accumulated latest mobility estimation result with the threshold set in advance (S806). As a result of the comparison, when the mobility is higher than the threshold, the RRM continuously periodically estimate the mobility (S804) and accumulates the estimated mobility (S805), and repeats the comparison with the threshold (S806).

When the mobility first becomes lower than the threshold after the terminal starts the communication with the base station, the RRM determines to perform handover led by the base station, and transmits the handover instruction to the terminal. At this time, the RRM determines a handover destination based on the group ID or the terminal ID accumulated in step S803, and notifies the handover destination to the terminal.

In the above-described embodiment, when the aircraft moves at a high speed, the communication is continued using the initially connected channel, and the handover at the high-speed movement is avoided. Following that, falling of the speed to some extent is determined, and the handover led by a base station in consideration of a stop gate destination is performed, so that an operation to free up the initially connected channel can be performed. Further, the stop gate destination is estimated based on the group ID or the terminal ID of the aircraft, a base station to be finally connected is determined, and the handover led by a base station can be realized. Therefore, the problem can be solved.

### Embodiment 2

In the above-described embodiment, a configuration in which the base stations individually exist has been described as an example. However, an embodiment of a collective base station can be considered, in which a main body of a base station is configured from one housing, the housing and a plurality of antennas are connected with an optical fiber and are arranged in an airport, and the one housing controls the plurality of antennas and a plurality of frequencies. In this case, the embodiment can be similarly performed by interpreting a portion described as a base station as a frequency (channel), and interpreting the handover between base stations as handover between frequencies.

What is claimed is:

1. A wireless communication system in which each of a plurality of base stations performs communication with a terminal including a group attribute using a different frequency channel, the base station receiving, in a connection procedure with a terminal, a terminal ID or a group ID of a group to which the terminal belongs from the terminal, transmitting the terminal ID or the group ID to an authentication device, receiving information extracted as a result of authentication based on the terminal ID or the group ID from the authentication device, measuring, regarding the terminal in data transmission/reception after completion of the connection procedure, mobility of the terminal, and instructing the terminal to be handed over to a handover destination based on the information received from the authentication device when the mobility of the terminal becomes a threshold set in advance or less.

2. The wireless communication system according to claim 1, wherein the base station performs the measurement of the mobility of the terminal based on transmission path quality estimated from a pilot signal received from the terminal.

3. The wireless communication system according to claim 1, wherein the base station performs the measurement of the mobility of the terminal based on variation of a report value of a CQI channel from the terminal.

4. A base station configured to communicate with a terminal including a group attribute, the base station receiving, in a connection procedure with a terminal, a terminal ID or a group ID of a group to which the terminal belongs from the terminal, transmitting the terminal ID or the group ID to an authentication device, receiving information extracted as a result of authentication based on the terminal ID or the group ID from the authentication device, measuring, regarding the terminal in data transmission/reception after completion of the connection procedure, mobility of the terminal, selecting a base station of a handover destination based on the information received from the authentication device when the mobility of the terminal becomes a threshold set in advance or less, and instructing the terminal to be handed over to the selected base station.

5. The base station according to claim 4, wherein the base station performs the measurement of the mobility of the terminal based on transmission path quality estimated from a pilot signal received from the terminal.

6. The base station according to claim 4, wherein the base station performs the measurement of the mobility of the terminal based on variation of a report value of a CQI channel from the terminal.

7. A wireless communication method in a wireless communication system in which each of a plurality of base stations performs communication with a terminal using a different frequency channel, the method comprising:
dividing a first frequency channel for initial connection and a second frequency channel for efficiently using a frequency resource; and
performing, by being led by a base station, handover from a first base station having the first frequency channel to a second base station having the second frequency channel based on mobility of the terminal.

8. The wireless communication method according to claim 7, wherein the first base station measures the mobility of the terminal based on transmission path quality estimated from a pilot signal received from the terminal, and performs the handover when a measurement result falls below a threshold set in advance.

9. The wireless communication method according to claim 7, wherein the first base station measures the mobility of the terminal based on variation of a report value of a CQI channel from the terminal, and performs the handover when a measurement result falls below a threshold set in advance.
